(19) United States
(12) Patent Application Publication
(10) Pub. No.: US 2015/0269429 A1
(43) Pub. Date: Sep. 24, 2015

(54) CORRECTION DEVICE, CORRECTION METHOD, AND COMPUTER PROGRAM PRODUCT

(71) Applicant: Kabushiki Kaisha Toshiba, Tokyo (JP)

(72) Inventors: Shihomi TAKAHASHI, Yokohama Kanagawa (JP); Kazunori IMOTO, Kawasaki Kanagawa (JP); Isao MIHARA, Shinagawa Tokyo (JP)

(21) Appl. No.: 14/644,017

(22) Filed: Mar. 10, 2015

(30) Foreign Application Priority Data
Mar. 20, 2014 (JP) 2014-058606

(51) Int. Cl. G06K 9/00; G06T 5/00

(52) U.S. Cl. CPC G06K 9/00402; G06T 5/00

(57) ABSTRACT

According to an embodiment, a correction device includes a processor, a display controller, an acquisition processor, a detector, and a correction processor. The processor is configured to generate a guide for content stored in the correction device. The display controller is configured to display the content on a display. The acquisition processor is configured to acquire data regarding a stroke on the display. The detector is configured to detect acceleration data regarding the stoke. The correction processor is configured to determine a corrected stroke based on the guide and the stroke when the acceleration is equal to or more than a threshold value. The display controller is configured to display the corrected stroke on the display.

### CROSS-REFERENCE TO RELATED APPLICATION

This application is based upon and claims the benefit of priority from Japanese Patent Application No. 2014-058606, filed on Mar. 20, 2014; the entire contents of which are incorporated herein by reference.

### FIELD

An embodiment described herein relates generally to a correction device, a correction method, and a computer program product.

### BACKGROUND

JP-A 2011-018228 (KOKAI) discloses a technique by which, during input of strokes handwriting-input by a user, when an acceleration sensor detects occurrence of an acceleration equal to or more a threshold value on a handwriting-input screen, strokes input in the period of detection are corrected by strokes input before and after the period of detection.

However, according to such a conventional technique as described above, it is not possible to correct strokes when an acceleration equal to or more than a threshold value has occurred at the input of strokes or when an acceleration equal to or more than a threshold value occurs at any time.

### BRIEF DESCRIPTION OF THE DRAWINGS

FIG. 1 is a configuration diagram of an example of a correction device according to an embodiment;

FIG. 2 is a diagram illustrating an example of a display screen for a content according to the embodiment;

FIG. 3 is a diagram illustrating an example of the display screen before correction of a stroke according to the embodiment;

FIG. 4 is a diagram illustrating an example of the display screen after correction of the stroke according to the embodiment;

FIG. 5 is a flowchart of an example of a process performed according to the embodiment;

FIG. 6 is a diagram illustrating an example of a display screen before correction of a stroke according to the embodiment;

FIG. 7 is a diagram illustrating an example of the display screen after correction of the stroke according to the embodiment;

FIG. 8 is a diagram illustrating an example of the display screen after correction of the stroke according to the embodiment; and

FIG. 9 is a diagram illustrating an example of a hardware configuration of the correction device according to the embodiment.

### DETAILED DESCRIPTION

According to an embodiment, a correction device includes a processor, a display controller, an acquisition processor, a detector, and a correction processor. The processor is configured to generate a guide for content stored in the correction device. The display controller is configured to display the content on a display. The acquisition processor is configured to acquire data regarding a stroke on the display. The detector is configured to detect acceleration data regarding the stoke. The correction processor is configured to determine a corrected stroke based on the guide and the stroke when the acceleration is equal to or more than a threshold value. The display controller is configured to display the corrected stroke on the display.

An embodiment will be described in detail with reference to the attached drawings.

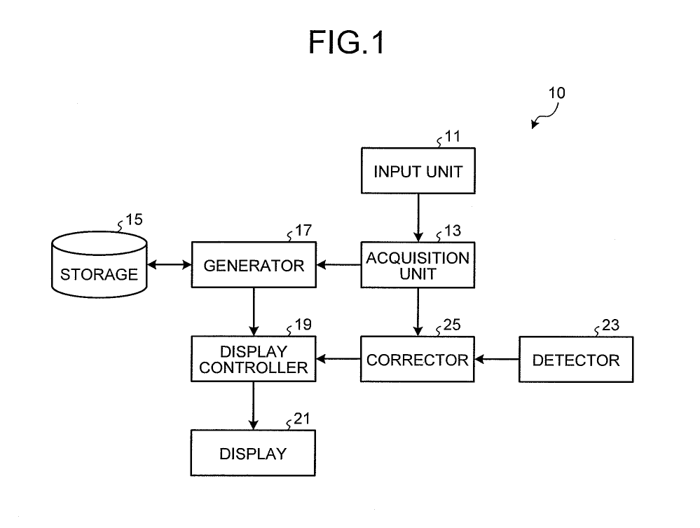

FIG. 1 is a configuration diagram of an example of a correction device 10 according to an embodiment. As illustrated in FIG. 1, the correction device 10 includes an input unit 11, an acquisition unit 13, a storage 15, a generator 17, a display controller 19, a display 21, a detector 23, and a corrector 25. The correction device 10 may be a smart phone, tablet terminal, or the like, for example.

The input unit 11 can be implemented by an input device capable of handwriting input, such as a touch panel, touch pad, mouse, or electronic pen, for example. The acquisition unit 13, the generator 17, the display controller 19, and the corrector 25 may be implemented by causing a processing device such as a CPU (Central Processing Unit) to execute programs, that is, via software, or may be implemented via hardware such as ICs (Integrated Circuits), or may be implemented by using a combination of software and hardware. The storage 15 can be implemented by a storage device allowing magnetic, optical, or electronic storage, such as a HDD (Hard Disk Drive), SSD (Solid State Drive), memory card, optical disc, ROM (Read Only Memory), or RAM (Random Access Memory), for example. The display 21 can be implemented by a display device such as a touch panel display or liquid crystal display, for example. The detector 23 can be implemented by an acceleration sensor or gyro sensor, for example.

The input unit 11 inputs into the correction device 10 a specification of a content or a handwriting stroke by a user.

The acquisition unit 13 acquires the specification of a content and the stroke input from the input unit 11.

The storage 15 stores one or more contents. In the embodiment, contents are assumed to be digital documents such as documents generated via word-processing software, spreadsheet software, presentation software, and viewing software, and web pages, and handwritten documents generated by a user inputting handwritten data, and the like. However, the contents are not limited to these documents but may be still images, moving images, and the like.

When the acquisition unit 13 acquires an input for specifying a content, the generator 17 acquires the content from the storage 15 and generates a guide. Specifically, the generator 17 generates a guide using structure information on constituent elements of the acquired content.

In the embodiment, the structure information is at least one of a base line for character string, outer shape of a text box, and a bounding box for graphics, but is not limited to them.

When the content is a digital document, the content may contain structure information in advance. When the content is a handwritten document, the content may be analyzed in advance to generate structure information and add the same to the content.

Alternatively, the structure information may contain a base line for a character string separated into words and phrases. When the content is a digital document, the digital document may be provided in advance with results of character conversion or separated into words and phrases by morphological analysis.

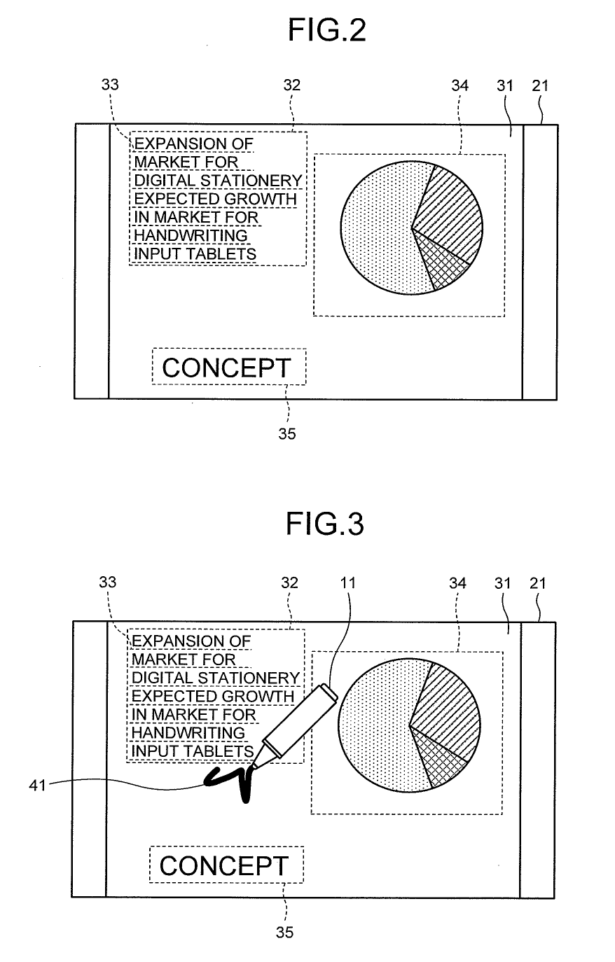

The display controller 19 displays the content acquired by the generator 17 on the display 21. FIG. 2 is a diagram illustrating an example of a display screen for a content 31 according to the embodiment. In the example of FIG. 2, the display 21 displays the content 31. In addition, in the example of FIG. 2, the display 21 displays text boxes 32, 35, a base line for character string 33, and a bounding box 34 as well as the content 31. The guide generated by the generator 17 may be displayed or not be displayed.

The detector 23 detects an acceleration. Specifically, the detector 23 detects an acceleration of the correction device 10.

When the acceleration detected by the detector 23 is equal to or more than a threshold value and the acquisition unit 13 has acquired a stroke, the corrector 25 uses the guide generated by the generator 17 to correct the stroke. Specifically, the corrector 25 projects the stroke onto the guide positioned in the direction of occurrence of the acceleration equal to or more than the threshold value.

The display controller 19 will be described again. The display controller 19 displays on the display 21 the stroke corrected by the corrector 25.

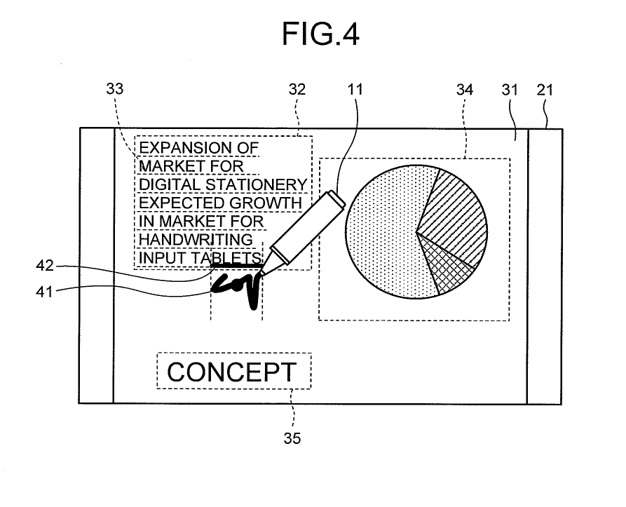

FIG. 3 is a diagram illustrating an example of the display screen before correction of a stroke 41 according to the embodiment. FIG. 4 is a diagram illustrating an example of the display screen after correction of the stroke 41 according to the embodiment. In the example of FIG. 3, since an acceleration equal to or more than a threshold value occurs in the upward and downward directions of the correction device 10 (upward and downward directions of FIG. 3), upward and downward blurs are generated at the stroke 41 input from the input unit 11. Thus, as illustrated in FIG. 4, the corrector 25 projects the stroke 41 onto the guide positioned in the direction of occurrence of the acceleration equal to or more than the threshold value (the base line for character string 33 in the example of FIG. 4) to form a corrected stroke 42.

The guide onto which a stroke to be corrected is projected may be decided based on priority according to the type of the guide or may be decided based on the distance from the stroke to be corrected.

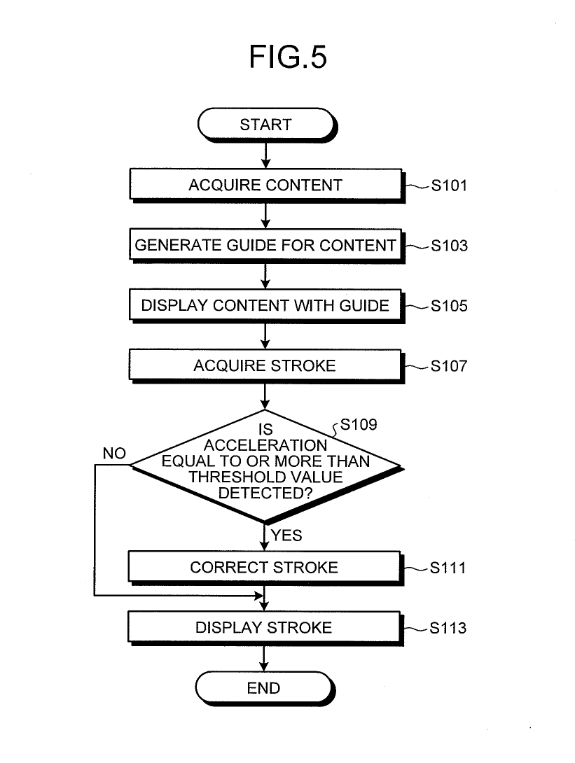

FIG. 5 is a flowchart of an example of a process performed at the correction device 10 according to the embodiment.

First, when the acquisition unit 13 acquires an input for specifying a content, the generator 17 acquires the content from the storage 15 (step S101) to generate a guide (step S103).

Subsequently, the display controller 19 displays on the display 21 the content acquired by the generator 17 together with the guide generated by the generator 17 (step S105).

Subsequently, the acquisition unit 13 acquires a stroke (step S107).

Subsequently, when an acceleration detected by the detector 23 is equal to or more than a threshold value (Yes at step S109), the corrector 25 uses the guide generated by the generator 17 to correct the stroke acquired by the acquisition unit 13 (step S111).

When the acceleration detected by the detector 23 is not equal to or more than the threshold value (No at step S109), step 5111 is not carried out.

Subsequently, the display controller 19 displays on the display 21 the stroke corrected by the corrector 25 or the stroke acquired by the acquisition unit 13 (step S113). The display controller 19 may display on the display 21 both of the stroke corrected by the corrector 25 and the stroke acquired by the acquisition unit 13.

According to the embodiment described above, when an acceleration equal to or more than a threshold value occurs, a stroke is corrected using a guide for a content. It is thus possible to correct the stroke regardless of occurrence form of an acceleration.

An example in the case where the content is a sentence will be described below.

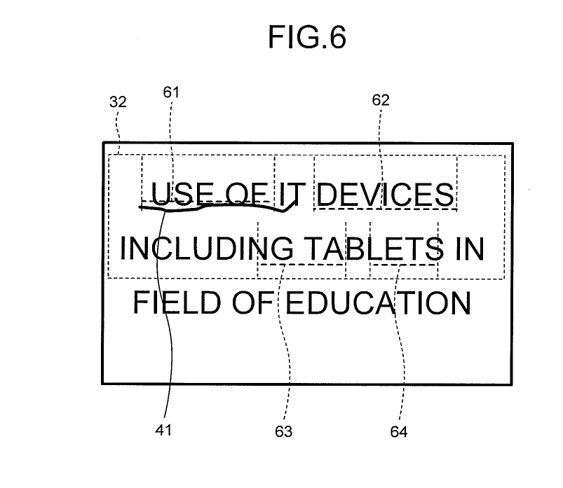

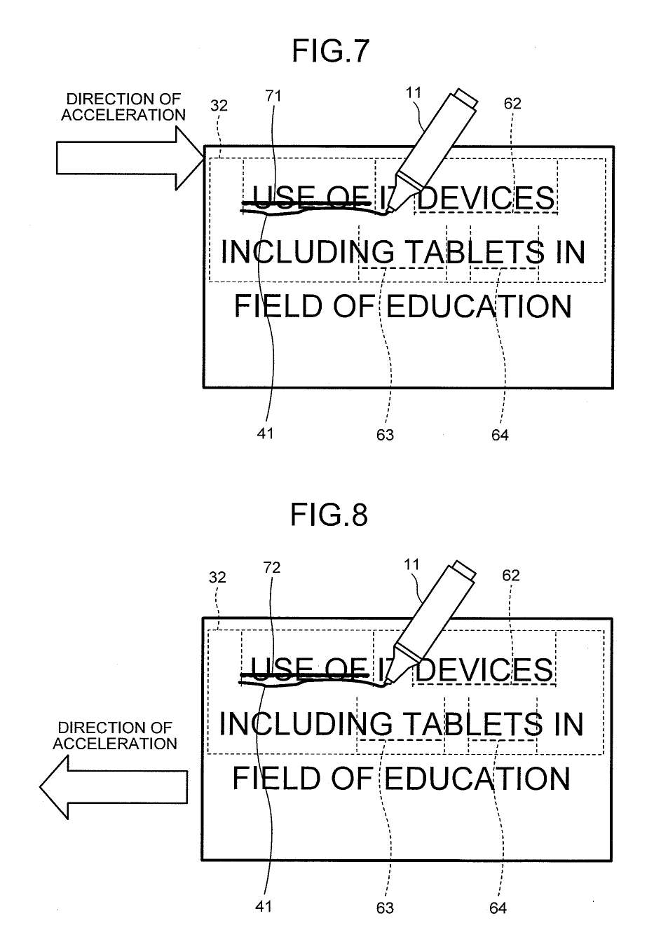

When an acceleration occurs in the direction of characters, start and end points of a stroke to be corrected are projected according to start and end points of a word. FIG. 6 is a diagram illustrating an example of a display screen before correction of a stroke 41 according to the embodiment. FIGS. 7 and 8 are diagrams illustrating an example of the display screen after correction of the stroke 41 according to the embodiment.

In the example of FIG. 7, during input of the stroke 41, an acceleration equal to or more than a threshold value occurs in the rightward direction of the correction device 10 (direction of an arrow in FIG. 7), and thus the stroke 41 is long in the rightward direction. Accordingly, as illustrated in FIG. 7, the corrector 25 projects the stroke 41 according to the positions of the start and end points of the guide situated in the direction of occurrence of the acceleration equal to or more than the threshold value (start and end points of a base line for character string 61 illustrated in FIG. 6) to form a corrected stroke 71.

In the example of FIG. 8, during input of the stroke 41, an acceleration equal to or more than a threshold value occurs in the leftward direction of the correction device 10 (direction of an arrow in FIG. 8), and thus the stroke 41 is short in the rightward direction. Accordingly, as illustrated in FIG. 8, the corrector 25 projects the stroke 41 according to the position of the start point of the guide situated in the direction of occurrence of the acceleration equal to or more than the threshold value (start point of the base line for character string 61 and start point of a base line for character string 62 illustrated in FIG. 6) to form a corrected stroke 72. Hardware Configuration

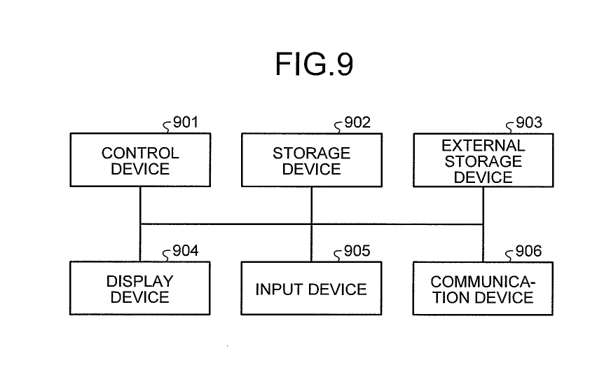

FIG. 9 is a diagram illustrating an example of a hardware configuration of the correction device 10 according to the embodiment. The correction device 10 according to the embodiment includes a control device 901 such as a CPU, a storage device 902 such as a ROM or a RAM, an external storage device 903 such as an HDD, a display device 904 such as a display, an input device 905 such as a keyboard or a mouse, and a communication device 906 such as a communication interface, and has a hardware configuration using a general computer.

A program to be executed in the correction device 10 according to the embodiment is stored and provided in the form of installable or executable files, in a computer-readable storage medium, as a computer program product, such as a CD-ROM, CD-R, memory card, DVD (Digital Versatile Disk), flexible disc (FD), and the like.

Alternatively, the program to be executed in the correction device 10 according to the embodiment may be stored in a computer connected to a network such as the Internet and provided by downloading through the network. Alternatively, the program to be executed in the correction device 10 according to the embodiment may be provided or distributed through a network such as the Internet. Alternatively, the program to be executed in the correction device 10 according to the embodiment may be incorporated in advance in a ROM or the like.

The program to be executed in the correction device 10 according to the embodiment has a module configuration in which the units described above are implemented on a computer. In terms of actual hardware, the CPU reads the program from the HDD into the RAM and executes the same to implement the foregoing units on the computer.

For example, the steps in the flowchart of the foregoing embodiment may be changed in order of execution, may be performed in plural at the same time, or may be performed in different order at each time of carrying out the embodiment.

As in the foregoing, according to the embodiment, it is possible to correct a stroke regardless of occurrence form of an acceleration.

While a certain embodiment has been described, this embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A correction device comprising:
a processor configured to generate a guide for content stored in the correction device;
a display controller configured to display the content on a display;
an acquisition processor configured to acquire data regarding a stroke on the display;
a detector configured to detect acceleration data regarding the stoke; and
a correction processor configured to determine a corrected stroke based on the guide and the stroke when the acceleration is equal to or more than a threshold value, wherein
the display controller is configured to display the corrected stroke on the display.

2. The device according to claim 1, wherein the processor is configured to generate the guide using structure information on constituent elements of the content.

3. The device according to claim 2, wherein the structure information comprises at least one of a base line for character string, outer shape of a text box, and a bounding box for graphics.

4. The device according to claim 1, wherein the correction processor is configured to project the stroke onto the guide positioned in a direction of the acceleration equal to or more than the threshold value.

5. A correction method performed in a correction device, comprising:
generating a guide for a content stored in the correction device;
displaying the content on a display;
acquiring data regarding a stroke on the display;
detecting acceleration data regarding the stroke;
correcting the stroke based on the guide and the stroke when the acceleration is equal to or more than a threshold value; and
displaying the corrected stroke on the display.

6. A computer program product comprising a computer-readable medium containing a program executed by a computer included in a correction device, the program causing the computer to execute:
generating a guide for a content stored in the correction device;
displaying the content on a display;
acquiring data regarding a stroke on the display;
detecting acceleration data regarding the stroke;
correcting the stroke based on the guide and the stroke when the acceleration is equal to or more than a threshold value; and
displaying the corrected stroke on the display.
